(19) United States
(12) Patent Application Publication
(10) Pub. No.: US 2018/0115424 A1
(43) Pub. Date: Apr. 26, 2018

(54) SECURING WIRELESS FRAMES WITHOUT ASSOCIATION

(71) Applicant: Avago Technologies General IP (Singapore) Pte. Ltd., Singapore (SG)

(72) Inventors: Nehru BHANDARU, San Jose, CA (US); Qi WANG, San Francisco, CA (US)

(21) Appl. No.: 15/789,908

(22) Filed: Oct. 20, 2017

Related U.S. Application Data
(60) Provisional application No. 62/412,767, filed on Oct. 25, 2016.
(60) Provisional application No. 62/412,207, filed on Oct. 24, 2016.

(51) Int. Cl. H04L 9/32; H04L 9/08; H04L 9/14; H04L 9/30

(52) U.S. Cl. CPC H04L 9/3226; H04L 9/0844; H04L 2209/80; H04L 9/14; H04L 9/30; H04L 9/0861

(57) ABSTRACT

In the subject system for securing wireless frames without association, an electronic device may establish a pre-association security mechanism with an access point prior to association with the access point. The electronic device may perform protected communication with the access point based on the established pre-association security mechanism without association with the access point. In some aspects, the access point may establish a pre-association security mechanism with a device prior to association with the device. The access point may perform protected wireless communication with the device based on the established pre-association security without the device being associated with the access point. In this manner, the electronic device and the access point may provide security for pre-association communication of wireless frames when the electronic device is not associated with the access point.

### CROSS-REFERENCE TO RELATED APPLICATIONS

The present application claims the benefit of U.S. Provisional Patent Application Ser. No. 62/412,207, entitled “Secure Pre-Association Transmissions,” filed on Oct. 24, 2016, and the benefit of U.S. Provisional Patent Application Ser. No. 62/412,767, entitled “Secure Pre-Association Transmissions,” filed on Oct. 25, 2016, both of which are hereby incorporated by reference in their entireties for all purposes.

### TECHNICAL FIELD

The present description relates generally to securing wireless communication between a device and an access point, including securing wireless communication between a device and an access point without the device being associated with the access point.

### BACKGROUND

In wireless communication via wireless local area network (WLAN), secured communication between authorized devices is desired. Hence, a device and an access point may perform an authentication process that may determine whether to allow communication between the device and the access point. The device may also perform an association process with the access point. Generally, the device may start performing secure communication with the access point after the authentication process and the association process. Further, when the device is associated with the access point, the associated device may communicate with other associated devices via the access point, using the access point as a communication bridge.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a system for securing wireless frames without association may be implemented in accordance with one or more implementations.

FIG. 2 illustrates an example network environment including an example electronic device that may implement a system for securing wireless frames without association in accordance with one or more implementations.

FIG. 3 illustrates an example network environment including an example access point (AP) that may implement a system for securing wireless frames without association in accordance with one or more implementations.

FIG. 4 illustrates a flow diagram of an example process of securing wireless frames without association in accordance with one or more implementations.

FIG. 5 illustrates a flow diagram of an example process of securing wireless frames without association in accordance with one or more implementations.

FIG. 6 illustrates a flow diagram of an example process of securing wireless frames in accordance with one or more implementations.

FIG. 7 illustrates a flow diagram of an example process of securing wireless frames without association in accordance with one or more implementations.

FIG. 8 illustrates a flow diagram of an example process of securing wireless frames without association in accordance with one or more implementations.

FIG. 9 illustrates a flow diagram of an example process of securing wireless frames in accordance with one or more implementations.

FIG. 10 illustrates a flow diagram of an example process of securing wireless frames in accordance with one or more implementations.

FIG. 11 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more implementations. In one or more implementations, structures and components are shown in block diagram form in order to avoid obscuring the concepts of the subject technology.

In wireless local area network (WLAN) communication, a wireless device may participate in authentication and association processes with an access point (AP) in order to become associated with, and begin securely communicating with, the access point. Once the wireless device is authenticated by, and associated with, the access point, the wireless frames communicated between the wireless device and the access point can be encrypted or otherwise secured. However, the wireless frames transmitted between the wireless device and/or the access point prior to the wireless device completing the association process may not be secured and therefore may be accessible to third parties and/or may otherwise pose a security risk.

In the subject system for securing wireless frames without association, a security mechanism may be established between a wireless device and an access point to secure wireless frames without the wireless device being associated with the access point. In this manner, the wireless device and the access point may securely communicate with one another prior to and/or without the wireless device being associated with the access point.

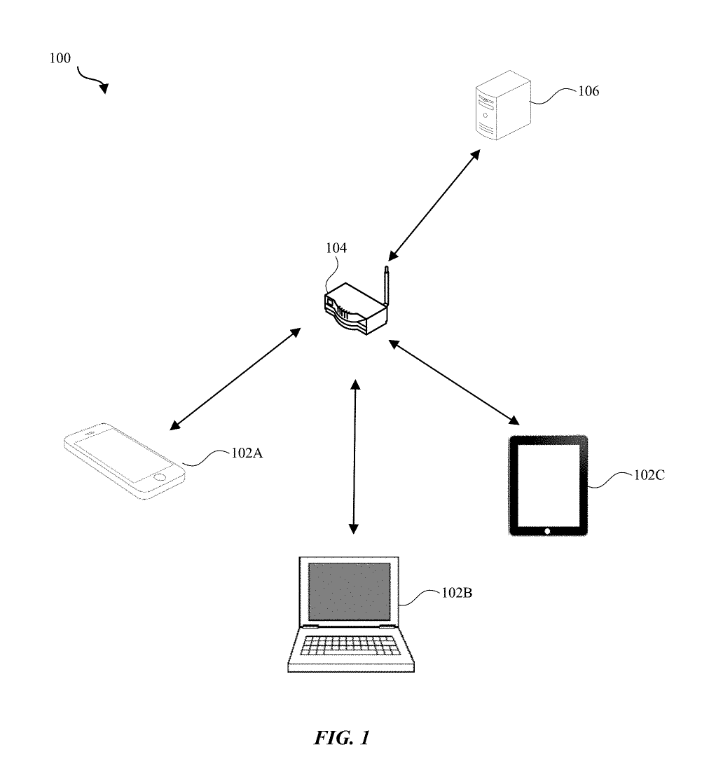

FIG. 1 illustrates an example network environment 100 in which a system for securing wireless frames without association may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

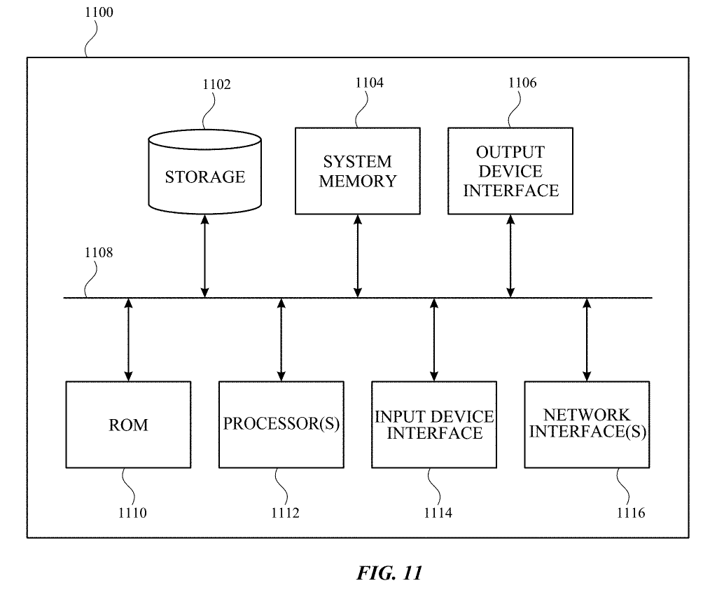

The network environment 100 includes one or more electronic devices 102A-C, an AP 104, and a server 106. The electronic devices 102A-C, the AP 104 and/or the server 106, may be, and/or may include all or part of, the electronic system discussed below with respect to FIG. 11.

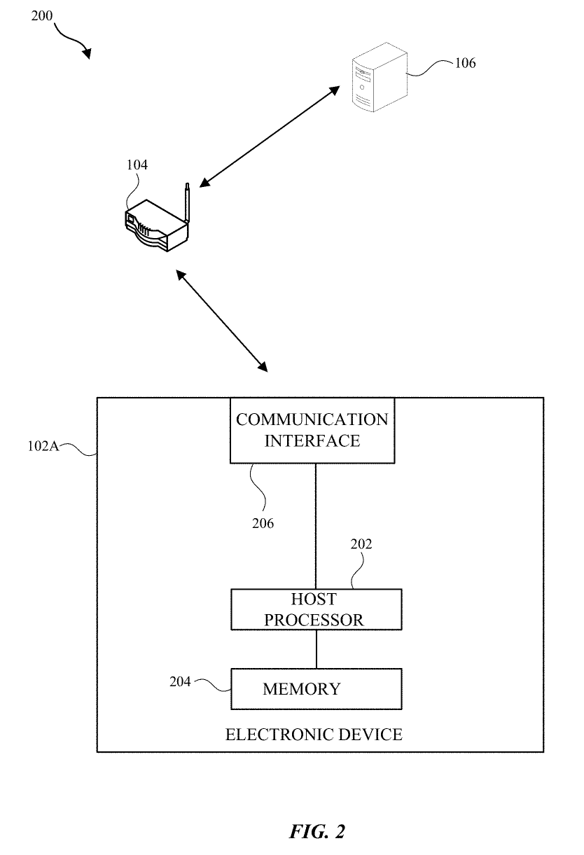

The electronic devices 102A-C may be, for example, portable computing devices such as laptop computers, smartphones, peripheral devices (e.g., digital cameras, headphones), tablet devices, wearable devices (e.g., watches, bands, etc.), wireless charging devices, or other appropriate devices that include a WLAN interface. The AP 104 also includes a WLAN interface. Thus, the electronic devices 102A-C may communicate with the AP 104 via WLAN communication (e.g., such as using one or more 802.11 protocols). The electronic devices 102A-C may also include one or more wireless interfaces, such as one or more NFC radios, Bluetooth radios, Zigbee radios, cellular radios, and/or other wireless radios. In FIG. 1, by way of example, the electronic device 102A is depicted as a mobile device, the electronic device 102B is depicted as a laptop computer, and the electronic device 102C is depicted as a tablet device. One or more of the electronic devices 102A-C may be, and/or may include all or part of, the electronic device discussed below with respect to FIG. 2 and/or the electronic system discussed below with respect to FIG. 11.

The AP 104 may include one or more communication interfaces such as one or more NFC radios, WLAN radios, Bluetooth radios, Zigbee radios, cellular radios, and/or other wireless radios to communicate with the server 106. The server 106 may be an authentication server that facilitates authentication of one or more electronic devices 102A-102C that attempt to access the AP 104.

The electronic device 102A may not be associated with the AP 104 until the electronic device 102A and the AP 104 complete an association process. Similarly, one or more electronic devices 102B-C may be or may not be associated with the AP 104, depending on whether an association process has been completed.

Wireless network technologies may include various types of WLANs. The WLAN communication may be performed according to an IEEE 8021.11 protocol. In WLAN communication, a station (e.g., electronic device 102A) may be associated with an AP (e.g., AP 104) via an association process. Upon completion of the association process, protection for WLAN frames (e.g., data frames, management frames) being communicated between the station may be provided. For example, in IEEE 802.11, the protection of WLAN frames is enabled after a 4-way handshake. In another example, in IEEE 802.11ai, the protection of WLAN frames is enabled after the key confirmation that confirms mutual possession of a same key by a station and an AP, which may be performed as a part of a fast initial link setup (FILS) exchange using association frames.

To provide protection for the WLAN frames, the station and the AP may establish a security mechanism. For example, establishing the security mechanism may involve a key establishment process to establish a security key for the station and the AP and a key confirmation process to confirm possession of the security key by the station and the AP. Generally, the key establishment process may take place during an authentication process (e.g., 802.11 authentication) and the key confirmation process may take place during an association process (e.g., 802.11 association). The authentication process may include the station transmitting an authentication frame to the AP and the AP responding with an authentication frame. When the authentication process is successfully completed, the station and the AP may perform the association process. The association process may include the station transmitting an association frame to the AP and the AP responding with an association frame. Because the key confirmation generally takes place as a part of the association process, the station and AP may not be able to communicate protected frames with each other until the association process completed. However, in some instances, communication using protected WLAN frames may be desired before or without the association between the station and the AP.

As discussed above, in one or more implementations, the electronic device 102A and the AP 104 may perform communication of protected WLAN frames upon successful completion of a key confirmation process. For example, in an authentication and key management (AKM) operation using a FILS operation, an 802.11 authentication process and an 802.11 association process may be performed and a key confirmation process may be performed as a part of the 802.11 association process between the electronic device 102A and the AP 104.

During the authentication process, the electronic device 102A may transmit an authentication frame to the AP 104 and, in response, the AP 104 may transmit an authentication frame to the electronic device 102A, where a key establishment process is a part of the authentication process. After the key establishment process, the electronic device 102A and the AP 104 may perform a key confirmation process by exchanging key confirmation elements, typically as a part of an association process. For example, the electronic device 102A may transmit a key confirmation element in an association request to the AP 104, such that the AP 104 may confirm mutual possession of a security key based on the key confirmation element from the electronic device 102A. After receiving the association request, the AP 104 may transmit another key confirmation element via an association response to the electronic device 102A, such that the electronic device 102A may confirm mutual possession of a security key based on the key confirmation element from the AP 104. Because the key confirmation process is typically completed with completion of the association process, the electronic device 102A and the AP 104 may not be able to perform communication of secured (or protected) WLAN frames before completion of the association process. Thus, the electronic device 102A and the AP 104 may not be able to exchange protected WLAN frames until the electronic device 102A is associated with the AP 104.

However, there may be WLAN frames that are communicated between the electronic device 102A and the AP 104 when the electronic device 102A is not associated with the AP 104. For example, WLAN frames may be communicated for pre-association fine timing measurement (FTM) protocol, a pre-association generic advertisement service (GAS)/access network query protocol (ANQP) for network discovery and selection, pre-association discovery of devices, etc. Therefore, providing a security mechanism for protecting WLAN frame communication between the electronic device 102A and the AP 104 when the electronic device 102A is not associated with the AP 104 may be desired.

The electronic device 102A and the AP 104 may implement the subject system for securing wireless frames without association so that the electronic device 102A and the AP 104 may securely communicate with each other without association. In particular, a security mechanism to ensure that the electronic device 102A and the AP 104 have an appropriate key for the protected communication of WLAN frames may be established before completion of the association process. Therefore, in the subject system, even when the electronic device 102A is not associated with the AP 104, the electronic device 102A and the AP 104 may be capable of protected WLAN frame communication with each other.

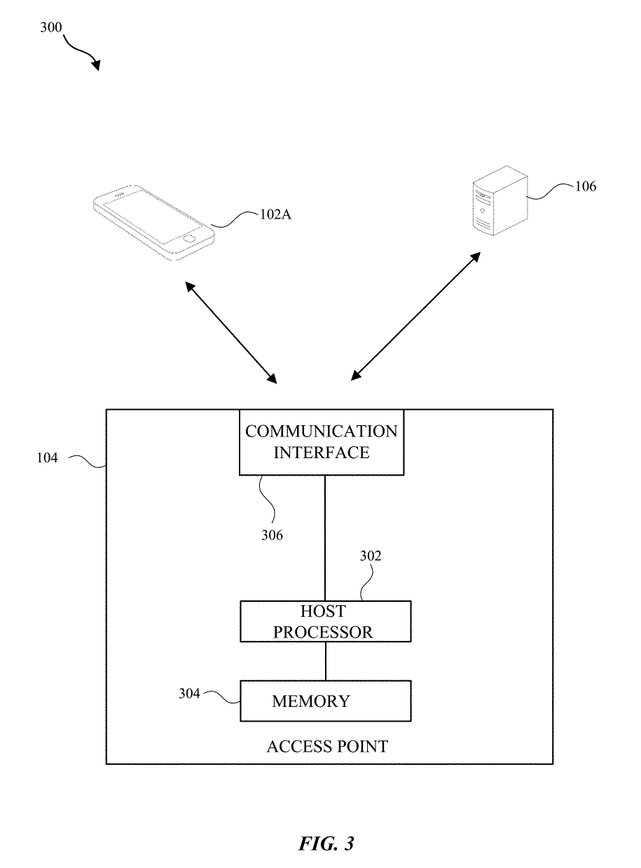

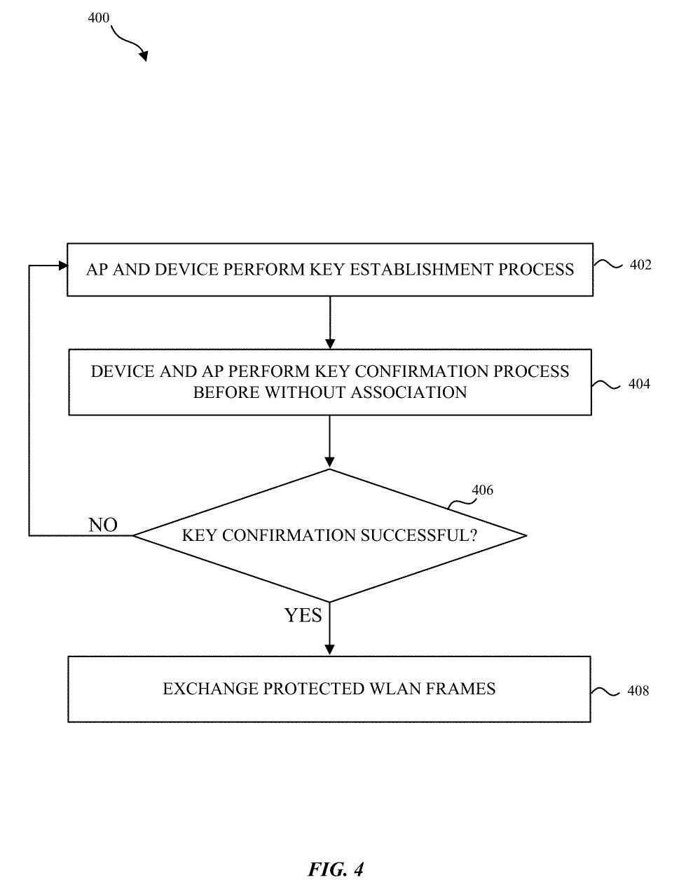

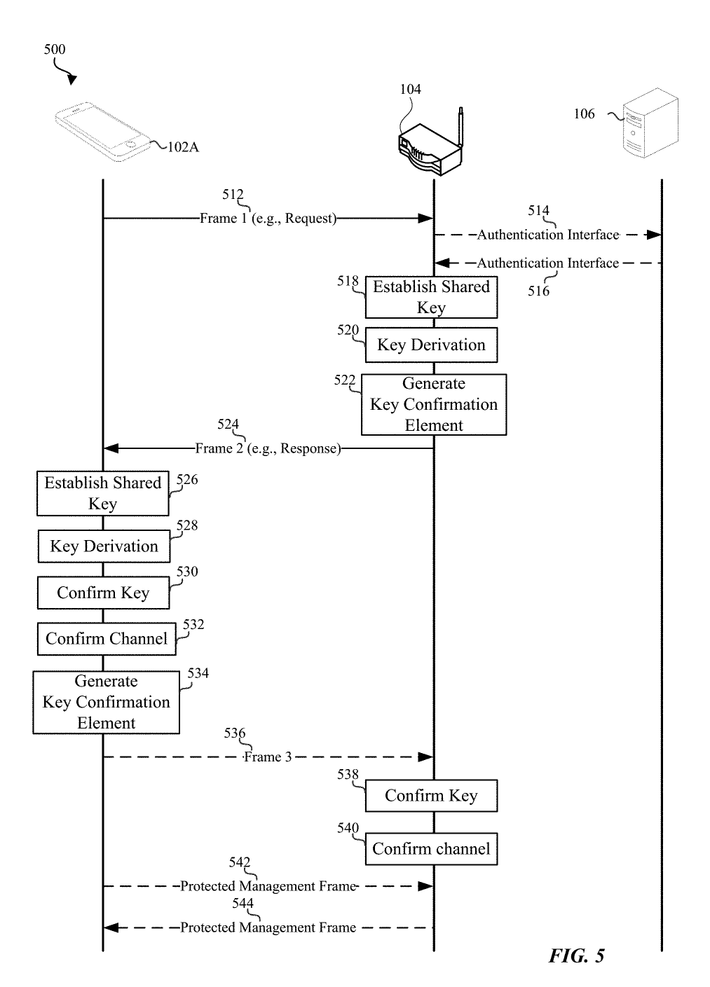

The protection of the WLAN frames may be provided for communication of WLAN frames between one electronic device and one AP, between one electronic device and multiple APs, between multiple electronic devices and multiple electronic devices, without association. Thus, for example, the protection of the WLAN frames being communicated between the electronic devices 102A-C and the AP 104 may be provided without association. An example electronic device 102A and an example AP 104 implementing the subject system a discussed further below with respect to FIG. 2 and FIG. 3, respectively, and example processes of the electronic device 102A and the AP 104 implementing the subject system are discussed further below with respect to FIGS. 4-5.

For explanatory purposes, the subject system is discussed herein with reference to securing WLAN communications. However, the subject system is not limited to securing WLAN communications and may be implemented to secure any wired or wireless communications, such as Bluetooth communication, MoCA communications, power line communications, and the like.

FIG. 2 illustrates an example network environment 200 including an example electronic device 102A that may implement a system for securing wireless frames without association in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 200 may include the electronic device 102A, the AP 104, and the server 106. The electronic device 102A may include, among other components, a host processor 202, a memory 204, and a communication interface 206. The host processor 202, which may also be referred to as an application processor or a processor, may include suitable logic, circuitry, and/or code that enable processing data and/or controlling operations of the electronic device 102A. In this regard, the host processor 202 may be enabled to provide control signals to various other components of the electronic device 102A.

The host processor 202 may also control transfers of data between various portions of the electronic device 102A. Additionally, the host processor 202 may enable implementation of an operating system or otherwise execute code to manage operations of the electronic device 102A. The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

The communication interface 206 may be used by the host processor 202 to communicate via a communication protocol, such as Bluetooth, BTLE, Zigbee, or NFC, Wi-Fi, cellular, Ethernet, MoCA, or the like. In one or more implementations, the communication interface 206 may be, may include, and/or may be communicatively coupled to a first radio frequency (RF) circuit, such as a Bluetooth circuit and/or an NFC circuit, a WLAN circuit, a cellular RF circuit, or the like.

In one or more implementations, one or more of the host processor 202, the memory 204, the communication interface 206, and/or one or more portions thereof, may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 illustrates an example network environment 300 including an example access point (AP) 104 that may implement a system for securing wireless frames without association in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 300 may include the electronic device 102A, the AP 104, and the server 106. The AP 104 may include, among other components, a host processor 302, a memory 304, and a communication interface 306. The host processor 302, which may also be referred to as an application processor or a processor, may include suitable logic, circuitry, and/or code that enable processing data and/or controlling operations of the AP 104. In this regard, the host processor 302 may be enabled to provide control signals to various other components of the AP 104.

The host processor 302 may also control transfers of data between various portions of the AP 104. Additionally, the host processor 302 may enable implementation of an operating system or otherwise execute code to manage operations of the AP 104. The memory 304 may include suitable logic, circuitry, and/or code that enable storage of various types of information such as received data, generated data, code, and/or configuration information. The memory 304 may include, for example, RAM, ROM, flash, and/or magnetic storage.

The communication interface 306 may be used by the host processor 302 to communicate via a communication protocol, such as Bluetooth, BTLE, Zigbee, or NFC, Wi-Fi, cellular, Ethernet, or the like. In one or more implementations, the communication interface 306 may be, may include, and/or may be communicatively coupled to a first RF circuit, such as a Bluetooth circuit and/or an NFC circuit, a WLAN circuit, a cellular RF circuit, or the like.

In one or more implementations, one or more of the host processor 302, the memory 304, the communication interface 306, and/or one or more portions thereof, may be implemented in software (e.g., subroutines and code), hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 4 illustrates a flow diagram of an example process 400 of securing wireless frames without association in accordance with one or more implementations. For explanatory purposes, the process 400 is primarily described herein with reference to the electronic device 102A and the AP 104 of FIGS. 1-3. However, the process 400 is not limited to the electronic device 102A and the AP 104. The electronic device 102A is also presented as an exemplary device and the operations described herein may be performed by any suitable device, such as one or more of the other electronic devices 102B-C of FIG. 1. The AP 104 is also presented as an exemplary device and the operations described herein may be performed by any suitable device. In some examples, the AP 104 may be a peer device of the electronic device 102A. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more of the blocks of the process 400 need not be performed and/or can be replaced by other operations.

As discussed above, in the subject system, the AP 104 and the electronic device 102A may establish a security mechanism for protecting WLAN frame communication without association between the electronic device 102A and the AP 104. In the example process 400, the security mechanism may be established by successfully completing a key establishment process and a key confirmation process. The key establishment process and the key confirmation process may be performed using one or more of various methods, such as extensible authentication protocol—re-authentication protocol (EAP-RP), an approach using a public key (e.g. Diffie-Hellman Exchange, certificates, etc.), an approach using a preshared key, extensible authentication protocol over LANs (EAPOL)/802.11 key descriptor exchange, etc.

In the example process 400, the AP 104 and the electronic device 102A (which are not associated with one another) may perform a key establishment process to establish a key for securely communicating with each other without association (402). For example, the electronic device 102A and the AP 104 may establish a shared key based on shared symmetric keys between the electronic device and the server 106 or based on a public key.

After the key establishment process, the electronic device 102A and the AP 104 may perform a key confirmation process without association between the electronic device 102A and the AP 104 (404), to ensure mutual possession of the shared key by the electronic device 102A and the AP 104. For example, the electronic device 102A may confirm whether a confirmation value generated by the AP 104 based on a shared key in the AP 104 matches a confirmation verifier generated by the electronic device 102A based on a shared key in the electronic device 102A. The AP 104 may also confirm whether a confirmation value generated by the electronic device 102A based on the shared key in the electronic device 102A 104 matches a confirmation verifier generated by the AP 104 based on the shared key in the AP 104.

The electronic device 102A and the AP 104 may determine whether the key confirmation process is successfully performed (406). If the electronic device 102A and/or the AP 104 fail to confirm the key, the key confirmation process is not successfully performed. If both the electronic device 102A and the AP 104 confirm the key, then the key confirmation process is successfully performed. For example, if the electronic device 102A finds a match between the confirmation value generated by the AP 104 and the confirmation verifier generated by the electronic device 102A and the AP 104 finds a match between the confirmation value generated by the electronic device 102A and the confirmation verifier generated by the AP 104, then the confirmation process is successfully performed. Otherwise, the key confirmation process is not successfully performed. If the key confirmation process is not successfully performed, the AP 104 and the electronic device 102A may perform a key establishment process again.

If the key confirmation process is successfully performed, the electronic device 102A and the AP 104 may start to exchange protected WLAN frames (408). For example, the electronic device 102A and the AP 104 may encrypt the WLAN frames using the shared key. Thus, the electronic device 102A and the AP 104 may start to exchange protected WLAN frames without completing an association process between the electronic device 102A and the AP 104.

FIG. 5 illustrates a flow diagram of an example process 500 of securing wireless frames without association in accordance with one or more implementations. For explanatory purposes, the process 500 is primarily described herein with reference to the electronic device 102A and the AP 104 of FIGS. 1-3. However, the process 500 is not limited to the electronic device 102A and the AP 104. The electronic device 102A is also presented as an exemplary device and the operations described herein may be performed by any suitable device, such as one or more of the other electronic devices 102B-C of FIG. 1. The electronic device 102A may be referred to as a station (STA). The AP 104 is also presented as an exemplary device and the operations described herein may be performed by any suitable device. In some examples, the AP 104 may be a peer device of the electronic device 102A. The server 106 is also presented as an exemplary device and the operations described herein may be performed by any suitable device. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more of the blocks of the process 500 need not be performed and/or can be replaced by other operations.

In the example process 500, when the electronic device 102A and the AP 104 are not associated with each other, the electronic device 102A generates and transmits a first frame to the AP 104 (512). The first frame may be a first authentication frame (e.g., for low-level authentication). The first frame may include an authentication algorithm that is used for the authentication process. The first frame may include robust security network (RSN) information that may be used to obtain or derive a key. For example, the RSN information may include a pairwise master key identifier (PMKID) that identifies a pairwise master key (PMK). The RSN information may further include information to identify an authentication and key management (AKM) and ciphers. The first frame may include wrapped data (e.g., with an extensible authentication protocol re-authentication protocol (EAP-RP) to be sent to a server such as the server 106). The first frame may include a supplicant nonce (SNonce) of the electronic device 102A to provide freshness to key derivation. The first frame may include a finite cyclic group (FCG) for an STA public key (e.g., STA ephemeral public key) that may be used to identify a public key mechanism used in the authentication process. The first frame may include an STA (ephemeral) public key (e.g., using finite field element, Diffie Hellman, etc.).

In some aspects, when the AP 104 receives the first frame and the first frame contains the wrapped data with an EAP-RP packet, the AP 104 may extract the EAR-RP packet from the wrapped data and forwards the EAP-RP packet to the server 106 (514). The server 106 may process the EAP-RP packet and perform authentication based on the EAP-RP packet to validate mutual possession of a root key between the electronic device 102A and the server 106. If the authentication server 106 successfully validates the mutual possession of the root key, the authentication server 106 may transmit an EAP-RP secret key (e.g., master session key (MSK)) with the EAP-Finish/Re-auth packet to the AP 104 (516). If the authentication server 106 does not validate the mutual possession of the root key, the authentication fails and thus the authentication server 106 may indicate an authentication failure to the AP 104 (516).

In one or more implementations, when the AP 104 receives the first frame including the STA public key (e.g., STA ephemeral public key), the AP 104 may establish a shared key (e.g., shared secret) based on the STA public key from the electronic device 102A and an AP private key of the AP 104 (518). The AP 104 may use the shared key to encrypt communication to the electronic device 102A. The shared key may be a Diffie Hellman shared secret.

The AP 104 derives a key (e.g., pairwise transient key (PTK)) based on information included in the first frame and information included in the second frame (520). For example, the key may be derived based on the SNonce and an ANonce, as well as an EAP-RP secret key if the server 106 is used for authentication, and/or a shared key (e.g., Diffie Hellman shared secret), where the SNonce is included in the first frame and the ANonce is included in the second frame. For example, the derived key may include at least one of an encryption key (e.g., a key encryption key) or a confirmation key (e.g., a key confirmation key).

The AP 104 generates a key confirmation element of an AP that includes a key authorization field (522). In some aspects where the server 106 is utilized for authentication, the AP 104 may generate the key authorization field based on a portion of the derived key (e.g., a confirmation key or the encryption key), an ANonce, and the SNonce, and, in some cases, further based on the AP public key (e.g., AP ephemeral public key) and the STA public key (e.g., STA ephemeral public key). In some aspects where the server 106 is not utilized for authentication, the AP 104 may generate the key authorization field by generating a digital signature using the AP private key based on the AP public key (e.g., AP ephemeral public key) as well as the STA public key (e.g., STA ephemeral public key). The AP 104 includes the key authorization field in the key confirmation element to be included in a second frame.

The AP 104 generates and transmits the second frame to the electronic device 102A (524). As discussed above, the key confirmation element is included in the second frame. The second frame may be a second authentication frame. The second frame may include the ANonce, the AP public key (e.g., AP ephemeral public key) (e.g., using finite field element, Diffie Hellman, etc.), and may further include a FCG for an AP public key to identify a private key mechanism used in the authentication process. The second frame may include and/or may indicate an authentication algorithm that is used for the authentication process. The second frame may include RSN information that may be used to obtain or derive a key. The second frame may include wrapped data (e.g., with the EAP-RP related information from the server 106). The second frame may include an FCG for the AP public key (e.g., AP ephemeral key) to identify a public key mechanism used in the authentication process. The second frame may include encrypted keys (e.g., key delivery elements). The second frame may include a message integrity code (MIC) that may be used to check for integrity of the second frame. The FCG may be a finite cyclic group that may use finite fields and/or elliptic curves.

The second frame may further include operating channel information of the AP. The operating channel information of the AP 104 may include information about a channel utilized by the AP 104, such as a channel and an operating class of the AP 104 as well as a country code. The second frame may include a MIC associated with the operating channel information for protection of the operating channel information. Alternatively, a HASH (e.g. SHA256) or a partial HASH (e.g. first 4 octets) of the operating channel information of the AP 104 may be included for validation.

In one or more implementations, when the electronic device 102A receives the second frame including the AP public key (e.g., AP ephemeral public key), the electronic device 102A may establish a shared key (e.g., shared secret) based on the AP public key from the AP 104 and the STA private key of the electronic device 102A (526). The electronic device 102A may use the shared key established by the electronic device 102A to encrypt communication to the AP 104. The shared key may be a Diffie Hellman shared secret.

Further, after receiving the second frame, the electronic device 102A derives a key (e.g., pairwise transient key (PTK)) based on information included in the first frame and information included in the second frame (528). For example, the key may be derived based on the SNonce and the ANonce, as well as an EAP-RP secret key if the server 106 is used for authentication, and/or a shared secret (e.g., Diffie Hellman shared secret), where the SNonce is included in the first frame and the ANonce is included in the second frame. For example, the derived key may include at least one of an encryption key (e.g., a key encryption key) or a confirmation key (e.g., a key confirmation key).

The electronic device 102A performs key confirmation by comparing a key authorization field of the key confirmation element received from the AP 104 with a key authorization verifier constructed by the electronic device 102A (530). In some aspects where the server 106 is utilized for authentication, the electronic device 102A may construct the key authorization verifier based on a portion of the derived key, the ANonce, and the SNonce, and, in some cases, further based on the AP public key (e.g., AP ephemeral public key) and the STA public key (e.g., STA ephemeral public key). In some aspects where the server 106 is not utilized for authentication, the electronic device 102A may generate the key authorization verifier based on the AP public key (e.g., AP ephemeral public key). If the key authorization field of the key confirmation element received from the AP 104 matches the key authorization verifier constructed by the electronic device 102A, the key confirmation at the electronic device 102A is successfully performed.

When the electronic device 102A receives the second frame, the electronic device 102A may confirm that a channel indicated by the operating channel information included in the second frame matches the current operating channel of the electronic device 102A (532). By confirming that the channel indicated by the received operating channel information matches the current operating channel of the electronic device 102A, man-in-the-middle (MITM) attacks where an attacking device may communicate frames on a different channel may be detected and prevented.

The electronic device 102A generates a key confirmation element of the electronic device 102A that includes a key authorization field (534). In some aspects where the server 106 is utilized for authentication, the electronic device 102A may generate the key authorization field based on a portion of the derived key (e.g., the confirmation key or the encryption key) that has been derived by the electronic device 102A, the SNonce, and the ANonce, and, in some cases, further based on the STA public key (e.g., STA ephemeral public key) and the AP public key (e.g., AP ephemeral public key). In some aspects where the server 106 is not utilized for authentication, the electronic device 102A may generate the key authorization field by generating a digital signature using the STA private key based on the STA public key (e.g., STA ephemeral public key) as well as the AP public key (e.g., AP ephemeral public key). The electronic device 102A includes the key authorization field in the key confirmation element to be included in a third frame.

The electronic device 102A generates and transmits a third frame to the electronic device 102A (536). The key confirmation element generated by the electronic device 102A may be included in the third frame. The third frame may further include an authentication algorithm, encrypted keys (e.g., key delivery elements), and a MIC that may be used to check for integrity of the third frame.

The third frame may further include operating channel information of the electronic device 102A. The operating channel information of the electronic device 102A may include information about a channel utilized by the electronic device 102A, such as an operating channel and an operating class of the electronic device 102A as well as a country code. The third frame may include a MIC associated with the operating channel information for protection of the operating channel information. Alternatively, a hash (e.g., SHA256) or a partial hash (e.g., first 4 octets) of the operating channel information of the electronic device 102A may be included in the third frame for validation.

In one or more implementations, the third frame may be a first protected frame communicated to the AP 104 after the key confirmation by the electronic device 102A. The transmission of the first protected frame by the electronic device 102A may implicitly indicate the key confirmation by the electronic device 102A.

The AP 104 performs key confirmation by comparing a key authorization field of the key confirmation element received from the electronic device 102A with a key authorization verifier constructed by the AP 104 (538). In some aspects where the server 106 is utilized for authentication, the AP 104 may construct the key authorization verifier based on a portion of the derived key, the SNonce, and the ANonce, and, in some cases, further based on the AP public key (e.g., AP ephemeral public key) and the STA public key (e.g., STA ephemeral public key). In some aspects where the server 106 is not utilized for authentication, the AP 104 may generate the key authorization verifier based on the STA public key (e.g., STA ephemeral public key). If the key authorization field of the key confirmation element received from the electronic device 102A matches the key authorization verifier constructed by the AP 104, key confirmation at the AP 104 is successfully performed.

When the AP 104 receives the third frame, the AP 104 may confirm that a channel indicated by the operating channel information included in the third frame matches the current operating channel of the AP 104 (540). By confirming that the channel indicated by the received operating channel information matches the current operating channel of the AP 104, MITM attacks where an attacking device may communicate frames on a different channel may be detected and prevented.

Once the key confirmation process is completed, the electronic device 102A and the AP 104 may communicate with each other using protected frames, for example by encrypting the frames using the established keys. Thus, the communication using the protected frames may begin without performing the association. The third frame may be a third authentication frame, which is separate from frames exchanged during an association process.

In one or more implementations, the communication of protected management frames may take place after the key confirmation by the AP 104. In particular, the electronic device 102A may transmit a protected management frame (e.g., association request) to the AP 104 (542). In response, the AP 104 may transmit another protected management frame (e.g., association response) to the electronic device 102A (544).

In one or more implementations, one or more association frames that are used during the association process may be protected frames (e.g., protected management frames). For example, after successful completion of the key confirmation process, the electronic device 102A and the AP 104 may perform the association process by communicating one or more association frames that may be protected frames. In one or more implementations, the association process may occur before the electronic device 102A transmits the third frame to the AP 104, and thus the third frame may be transmitted during or after the association process. Then, the communication using the protected frames may begin during the association process but before completion of the association process.

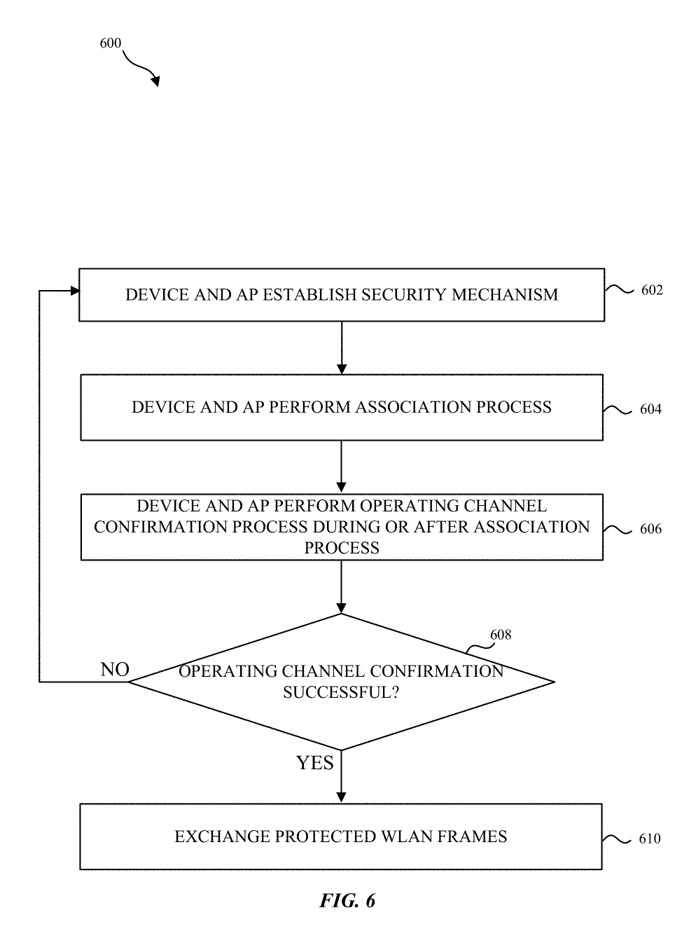

FIG. 6 illustrates a flow diagram of an example process 600 of securing wireless frames in accordance with one or more implementations. For explanatory purposes, the process 600 is primarily described herein with reference to the electronic device 102A and the AP 104 of FIGS. 1-3. However, the process 600 is not limited to the electronic device 102A and the AP 104. The electronic device 102A is also presented as an exemplary device and the operations described herein may be performed by any suitable device, such as one or more of the other electronic devices 102B-C of FIG. 1. The AP 104 is also presented as an exemplary device and the operations described herein may be performed by any suitable device. In some examples, the AP 104 may be a peer device of the electronic device 102A. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more of the blocks of the process 600 need not be performed and/or can be replaced by other operations.

During or after the association process to associate the electronic device 102A with the AP 104, an operating channel confirmation process may be performed to confirm that a channel utilized by the electronic device 102A matches a channel utilized by the AP 104. In the example process 400, the electronic device 102A and the AP 104 may establish a security mechanism (602). While establishing the security mechanism, the AP 104 and the electronic device 102A may exchange messages that include operating channel information of the electronic device 102A and/or operating channel information of the AP 104, where the messages may be a part of the process for establishing the security mechanism. For example, the security mechanism may be based on a 802.11 security mechanism. For example, the security mechanism may be established using at least one of a FILS process, a fast basic service set (BSS) transition, a four way pairwise key handshake process, or a two way group handshake process.

The electronic device 102A and the AP 104 may perform an association process (604). The electronic device 102A and the AP 104 may perform an operating channel confirmation process based on the operating channel information exchanged during the establishment of the security mechanism (606). For example, when the electronic device 102A receives, from the AP 104, a message indicating a channel utilized by the AP 104, the electronic device 102A may confirm that the channel indicated by the message from the AP 104 matches a channel utilized by the electronic device 102A. For example, when the AP 104 receives, from the electronic device 102A, a message indicating the channel utilized by the electronic device 102A, the AP 104 may confirm that the channel indicated by the message from the electronic device 102A matches the channel utilized by the AP 104. The operating channel confirmation process may be performed during or after the association process.

The electronic device 102A and the AP 104 may determine whether the operating channel confirmation process is successfully performed (608). If the electronic device 102A and/or the AP 104 fail to confirm that the channel utilized by the electronic device 102A matches the channel utilized by the AP 104, the operating channel confirmation process is not successfully performed. If both the electronic device 102A and the AP 104 confirm that the channel utilized by the electronic device 102A matches the channel utilized by the AP 104, the operating channel confirmation process is successfully performed.

If the operating channel confirmation process is successfully performed, the electronic device 102A and the AP 104 may start to exchange protected WLAN frames (610). If the operating channel confirmation process is not successfully performed, the AP 104 and the electronic device 102A may establish the security mechanism again.

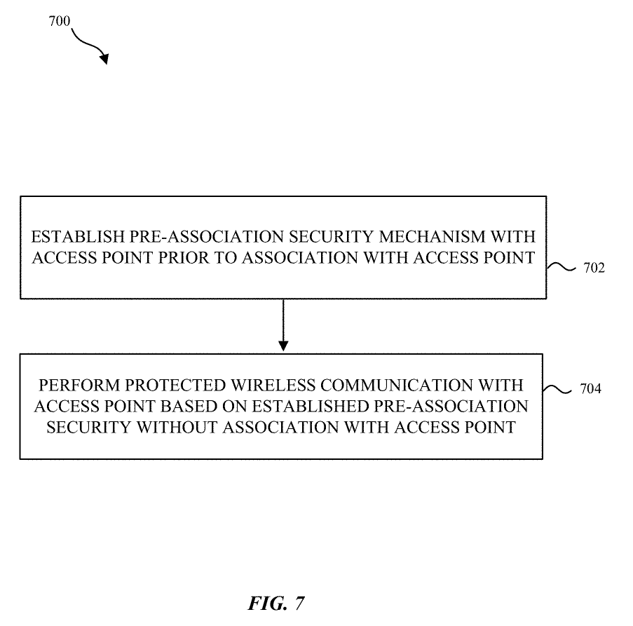

FIG. 7 illustrates a flow diagram of example process 700 of securing wireless frames without association in accordance with one or more implementations. For explanatory purposes, the process 700 is primarily described herein with reference to the electronic device 102A of FIGS. 1-2. However, the process 700 is not limited to the electronic device 102A, and one or more blocks (or operations) of the process 700 may be performed by one or more other components of the electronic device 102A. The electronic device 102A also is presented as an exemplary device and the operations described herein may be performed by any suitable device, such as one or more of the other electronic devices 102B-C. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more of the blocks of the process 700 need not be performed and/or can be replaced by other operations.

In the process 700, the host processor 202 of the electronic device 102A establishes a pre-association security mechanism with an AP 104 prior to association with the AP 104 (e.g., via the communication interface 206) (702). The host processor 202 of the electronic device 102A performs protected wireless communication with the AP 104 based on the established pre-association security mechanism without association with the AP 104 (e.g., via the communication interface 206) (704). As discussed above, a station and an AP may establish a security mechanism before completion of the association process, such that the station and the AP may communicate with each other using protected frames prior to or without the association process.

In one or more implementations, the host processor 202 may establish the pre-association security by performing a key establishment process and a key confirmation process, where the electronic device 102A is unassociated with the AP 104 and the key establishment and the key confirmation process are performed prior to completion of an association process to associate with the AP 104. For example, as discussed above, the security mechanism may be established by successfully completing a key establishment process and a key confirmation process, prior to or without association between the electronic device 102A and the AP 104.

In one or more implementations, the host processor 202 may establish the pre-association security by: transmitting, to the AP 104, a first communication frame including first key information for the key establishment process at the AP 104, receiving, from the AP 104, a second communication frame including second key information for the key establishment process at the electronic device 102A and a key confirmation information of the AP 104 for the key confirmation process at the electronic device 102A, and performing the key confirmation process at the electronic device 102A based on the key confirmation information of the AP 104 without the association process with the AP 104. The first key information may include a device public key (e.g., device ephemeral public key) and the second key information may include an access point public key (e.g., AP ephemeral public key). The first key information may further include an SNonce and the second key information may further include ANonce. In one or more implementations, the first communication frame may be a first authentication frame and the second communication frame is a second authentication frame.

In one or more implementations, the host processor 202 may perform the key establishment process at the electronic device 102A by establishing a shared key of the electronic device 102A based on the second key information included in the key information of the AP 104. For example, the electronic device 102A may establish a shared key (e.g., shared secret) based on the AP public key included in the second frame from the AP 104 as well as the STA private key of the electronic device 102A.

In one or more implementations, the key confirmation information of the AP 104 may be a key confirmation element including an access point key authorization field that is based on the first key information and the second key information. The host processor 202 may perform the key confirmation process by: generating a key verifier of the electronic device 102A based on the confirmation key, the first key information, and the second key information or based on the device public key, and confirming that the access point key authorization field matches the key verifier of the electronic device 102A. For example, in some aspects, the electronic device 102A may construct the key authorization verifier based on a portion of the derived key, the ANonce, and the SNonce, and, in some cases, further based on the AP public key (e.g., AP ephemeral public key) and the STA public key (e.g., STA ephemeral public key). For example, in some aspects, the electronic device 102A may generate the key authorization verifier based on the AP public key (e.g., AP ephemeral public key).

In one or more implementations, the host processor 202 may perform the key confirmation further by: generating a key authorization field of the device based on the first key information and the second key information and further based on the confirmation key or a private key of the device, and transmitting, to the AP 104, a third communication frame including a key confirmation element of the electronic device 102A, the key confirmation element of the electronic device 102A including the key authorization field of the electronic device 102A. For example, in some aspects, the electronic device 102A may generate the key authorization field based on a portion of the derived key that has been derived by the electronic device 102A, the SNonce, and the ANonce, and, in some cases, further based on the STA public key (e.g., STA ephemeral public key) and the AP public key (e.g., AP ephemeral public key). For example, in some aspects, the electronic device 102A may generate the key authorization field by generating a digital signature using the STA private key based on the STA public key (e.g., STA ephemeral public key) as well as the AP public key (e.g., AP ephemeral public key). In one or more implementations, the third communication frame may be a first protected frame being communicated to the AP 104. In one or more implementations, the third communication frame may be an association frame including an association request to associate with the AP 104.

The host processor 202 may establish the pre-association security further by: receiving operating channel information of the AP 104 from the AP 104 via the second communication frame, the operating channel information of the AP 104 indicating a channel utilized by the AP 104, and confirming that the channel utilized by the AP 104 matches a channel utilized by the electronic device 102A. For example, by confirming that the channel indicated by the received operating channel information matches the current operating channel of the electronic device 102A, MITM attacks where an attacking device may communicate frames on a different channel may be detected and prevented. The host processor 202 may establish the pre-association security further by transmitting operating channel information of the electronic device 102A to the AP 104 via the third communication frame, operating channel information of the electronic device 102A indicating the channel utilized by the electronic device 102A.

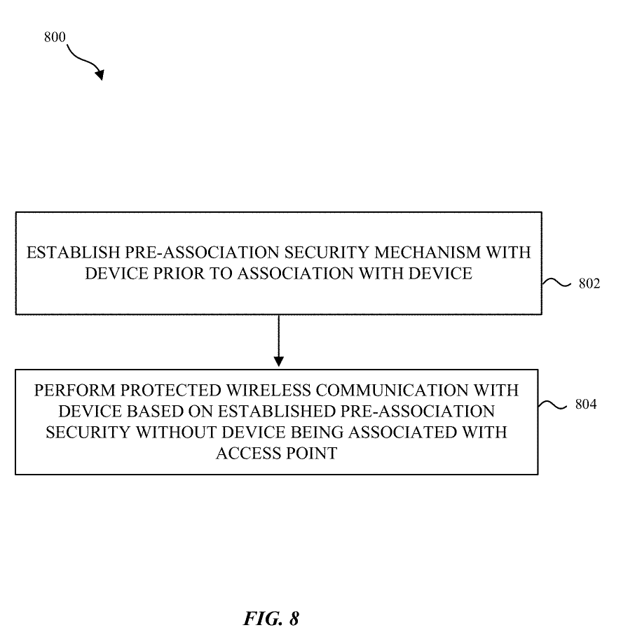

FIG. 8 illustrates a flow diagram of example process 800 of securing wireless frames without association in accordance with one or more implementations. For explanatory purposes, the process 800 is primarily described herein with reference to the AP 104 of FIGS. 1 and 3. However, the process 800 is not limited to the AP 104, and one or more blocks (or operations) of the process 800 may be performed by one or more other components of the AP 104. The AP 104 also is presented as an exemplary device and the operations described herein may be performed by any suitable device. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more of the blocks of the process 800 need not be performed and/or can be replaced by other operations.

The host processor 302 of the AP 104 establishes a pre-association security mechanism with an electronic device 102A prior to association with the electronic device 102A (e.g., via the communication interface 306) (802). The host processor 302 of the AP 104 performs protected wireless communication with the electronic device 102A based on the established pre-association security mechanism without the electronic device 102A being associated with the AP 104 (e.g., via the communication interface 206) (804). As discussed above, a station and an AP may establish a security mechanism before completion of the association process, such that the station and the AP may communicate with each other using protected frames prior to or without performing the association process.

The host processor 302 may establish the pre-association security by performing a key establishment process and a key confirmation process, where the electronic device 102A is unassociated with the AP 104 and the key establishment and the key confirmation process are performed prior to completion of an association process to associate the electronic device 102A with the AP 104. For example, as discussed above, the security mechanism may be established by successfully completing a key establishment process and a key confirmation process, prior to or without association between the electronic device 102A and the AP 104.

In one or more implementations, the host processor 302 may establish the pre-association security by: receiving, from the electronic device 102A, a first communication frame including first key information for the key establishment process at the AP 104, transmitting, to the electronic device 102A, a second communication frame including second key information for the key establishment process at the electronic device 102A and a key confirmation information of the AP 104 for the key confirmation process at the electronic device 102A, receiving, from the electronic device 102A, a third communication frame including a key information element of the electronic device 102A, and performing the key confirmation process at the AP 104 based on the key confirmation information of the electronic device 102A without the association process with the electronic device 102A. The first key information may include a device public key (e.g., device ephemeral public key) and the second key information may include an access point public key (e.g., AP ephemeral public key). The first key information may further include an SNonce and the second key information may further include ANonce.

In one or more implementations, the first communication frame may be a first authentication frame and the second communication frame may be a second authentication frame. In one or more implementations, the third communication frame may be an association frame including an association request to associate with the access point. In one or more implementations, the third communication frame may be a first protected frame being communicated to the access point.

In one or more implementations, the host processor 302 may perform the key establishment process at the AP 104 by establishing a shared key of the AP 104 based on the first key information. For example, the AP 104 may establish a shared key (e.g., shared secret) based on the STA public key included in the second frame from the electronic device 102A as well as the AP private key of the AP 104.

In one or more implementations, the key confirmation information is a key confirmation element of the electronic device 102A including a device key authorization field that is based on a shared key of the electronic device 102A, the first key information, and the second key information. The host processor 302 may perform the key confirmation process by: deriving a confirmation key based on the shared key, the first key information, and the second key information, generating a key verifier of the AP 104 based on the confirmation key, the first key information, and the second key information or based on the access point public key, and confirming that the device key authorization field matches the key verifier of the AP 104. For example, in some aspects, the AP 104 may construct the key authorization verifier based on a portion of the derived key, the SNonce, and the ANonce, and, in some cases, further based on the AP public key (e.g., AP ephemeral public key) and the STA public key (e.g., STA ephemeral public key). For example, in some aspects, the AP 104 may generate the key authorization verifier based on the STA public key (e.g., STA ephemeral public key). If the key authorization field of the key confirmation element received from the electronic device 102A matches the key authorization verifier constructed by the AP 104, key confirmation at the AP 104 is successfully performed.

In one or more implementations, the host processor 302 may perform the key confirmation process further by: generating a key authorization field of the AP 104 based on the first key information and the second key information and further based on the confirmation key or a private key of the AP, and generating a key confirmation element of the AP 104 that includes the key authorization field of the AP 104, where the key confirmation information of the AP 104 is the key confirmation element. For example, in some aspects, the AP 104 may generate the key authorization field based on a portion of the derived key, an ANonce, and the SNonce, and, in some cases, further based on the AP public key (e.g., AP ephemeral public key) and the STA public key (e.g., STA ephemeral public key). For example, in some aspects, the AP 104 may generate the key authorization field by generating a digital signature using the AP private key based on the AP public key (e.g., AP ephemeral public key) as well as the STA public key (e.g., STA ephemeral public key).

In one or more implementations, the host processor 302 may establish the pre-association security further by: receiving operating channel information of the electronic device 102A from the electronic device 102A via the third communication frame, the operating channel information of the electronic device 102A indicating a channel utilized by the electronic device 102A, and confirming that the channel utilized by the electronic device 102A matches a channel utilized by the AP 104. By confirming that the channel indicated by the received operating channel information matches the current operating channel of the AP 104, MITM attacks where an attacking device may communicate frames on a different channel may be detected and prevented.

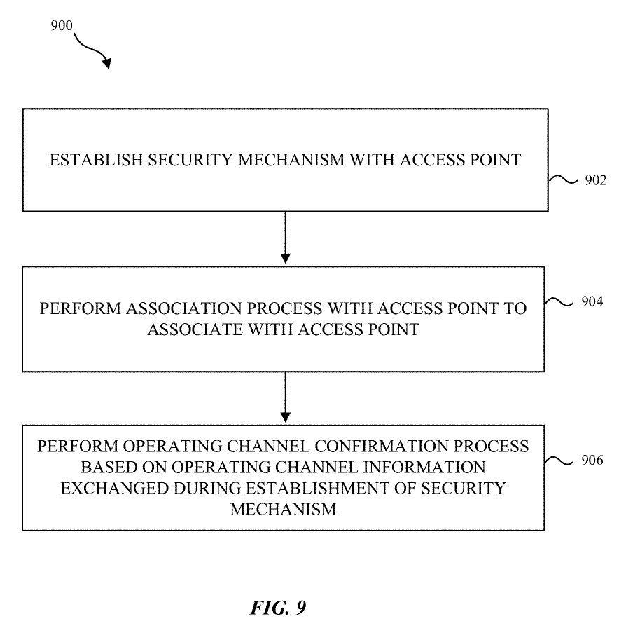

FIG. 9 illustrates a flow diagram of example process 900 of securing wireless frames in accordance with one or more implementations. For explanatory purposes, the process 900 is primarily described herein with reference to the electronic device 102A of FIGS. 1-2. However, the process 900 is not limited to the electronic device 102A, and one or more blocks (or operations) of the process 900 may be performed by one or more other components of the electronic device 102A. The electronic device 102A also is presented as an exemplary device and the operations described herein may be performed by any suitable device, such as one or more of the other electronic devices 102B-C. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more of the blocks of the process 900 need not be performed and/or can be replaced by other operations.

The host processor 202 of the electronic device 102A may establish a security mechanism with the AP 104 (902). The host processor 202 may perform an association process with the AP 104 to associate with the AP 104 (904). The host processor 202 may perform an operating channel confirmation process based on operating channel information exchanged during the establishment of the security mechanism (906). The operating channel confirmation process may be performed during or after the association process.

The host processor 202 may perform the operating channel confirmation process by confirming (e.g., cryptographically) that the channel utilized by the access point matches the channel utilized by the electronic device 102A, where the channel utilized by the access point is indicated by the operating channel information received from the AP 104. The host processor 202 may perform the operating channel confirmation process further by transmitting operating channel information indicating the channel utilized by the electronic device 102A to the AP 104, such that the AP 104 may confirm that the channel utilized by the AP 104 matches the channel utilized by the electronic device 102A based on the operating channel information from the electronic device 102A. In one or more implementations, the operating channel confirmation process may be performed using a MIC. In one or more implementations, the security mechanism may be established using at least one of a FILS, a fast basic service set (BSS) transition, a four way pairwise key handshake process, or a two way group handshake process.

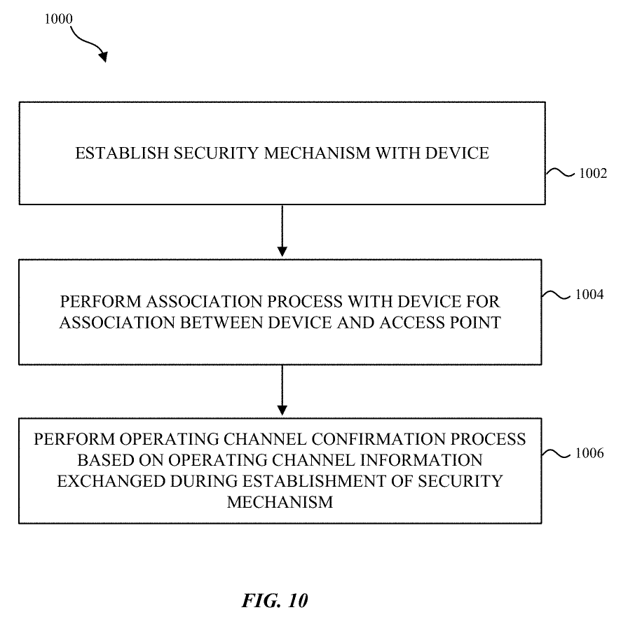

FIG. 10 illustrates a flow diagram of example process 1000 of securing wireless frames without association in accordance with one or more implementations. For explanatory purposes, the process 1000 is primarily described herein with reference to the AP 104 of FIGS. 1 and 3. However, the process 1000 is not limited to the AP 104, and one or more blocks (or operations) of the process 1000 may be performed by one or more other components of the AP 104. The AP 104 also is presented as an exemplary device and the operations described herein may be performed by any suitable device. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more of the blocks of the process 1000 need not be performed and/or can be replaced by other operations.

The host processor 302 of the AP 104 may establish a security mechanism with the electronic device 102A (1002). The host processor 302 may perform an association process with the electronic device 102A for association between the electronic device 102A and the AP 104 (1004). The host processor 302 may perform an operating channel confirmation process based on operating channel information exchanged during the establishment of the security mechanism (1006). The operating channel confirmation process may be performed during or after the association process.

The host processor 302 of the AP 104 may perform the operating channel confirmation process by confirming (e.g., cryptographically) that the channel utilized by the AP 104 matches the channel utilized by the electronic device 102A, where the channel utilized by the electronic device 102A is indicated by the operating channel information received from the electronic device 102A. The host processor 302 may perform the operating channel confirmation process further by transmitting operating channel information indicating the channel utilized by the AP 104 to the electronic device 102A, such that the electronic device 102A may confirm that the channel utilized by the electronic device 102A matches the channel utilized by the AP 104 based on the operating channel information from AP 104. In one or more implementations, the operating channel confirmation process may be performed using a MIC. In one or more implementations, the security mechanism may be established using at least one of a FILS, a fast BSS transition, a four way pairwise key handshake process, or a two way group handshake process.

FIG. 11 illustrates an electronic system 1100 with which one or more implementations of the subject technology may be implemented. The electronic system 1100 can be, and/or can be a part of, one or more of the electronic devices 102A-C, and/or the AP 104 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a floppy disk, flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input and output device interfaces 1114 and 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, such as the access point 104 shown in FIG. 1, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying,” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device, comprising:
at least one processor configured to:
establish pre-association security with an access point prior to association with the access point; and
perform protected wireless communication with the access point based on the established pre-association security without association with the access point.

2. The device of claim 1, wherein the at least one processor is configured to establish the pre-association security by performing a key establishment process and a key confirmation process, and
wherein the device is unassociated with the access point and the key establishment and the key confirmation process are performed prior to completion of an association process to associate with the access point.

3. The device of claim 2, wherein the at least one processor is configured to establish the pre-association security by:
transmitting, to the access point, a first communication frame including first key information for the key establishment process at the access point;
receiving, from the access point, a second communication frame including second key information for the key establishment process at the device and a key confirmation information of the access point for the key confirmation process at the device; and
performing the key confirmation process at the device based on the key confirmation information of the access point without the association process with the access point.

4. The device of claim 3, wherein the first key information includes at least one of a device public key or a device nonce, and wherein the second key information includes at least one of an access point public key or an access point nonce.

5. The device of claim 3, wherein the at least one processor is configured to perform the key establishment process by:
establishing a shared key of the device based on the second key information.

6. The device of claim 5, wherein the key confirmation information of the access point is a key confirmation element including an access point key authorization field that is based on the first key information and the second key information, and
the at least one processor is configured to perform the key confirmation process by:
deriving a confirmation key based on the shared key, the first key information, and the second key information;
generating a key verifier of the device based on the confirmation key, the first key information, and the second key information or based on a device public key; and
confirming that the access point key authorization field matches the key verifier of the device.

7. The device of claim 6, wherein the at least one processor is configured to perform the key confirmation process by:
generating a key authorization field of the device based on the first key information and the second key information and further based on the confirmation key or a private key of the device; and
transmitting, to the access point, a third communication frame including a key confirmation element of the device, the key confirmation element of the device including the key authorization field of the device.

8. The device of claim 7, wherein the third communication frame is an association frame including an association request to associate with the access point.

9. The device of claim 7, wherein the at least one processor is configured to establish the pre-association security by:
receiving operating channel information of the access point from the access point via the second communication frame, the operating channel information of the access point indicating a channel utilized by the access point; and
confirming that the channel utilized by the access point matches a channel utilized by the device.

10. The device of claim 7, wherein the at least one processor is configured to establish the pre-association security further by:
transmitting operating channel information of the device to the access point via the third communication frame, the operating channel information of the device indicating a channel utilized by the device.

11. A method comprising:
establishing, by an access point, a pre-association security mechanism with a device prior to association with the device; and
performing protected wireless communication with the device based on the established pre-association security without the device being associated with the access point.

12. The method of claim 11, wherein the establishing the pre-association security comprises performing a key establishment process and a key confirmation process, and wherein the device is unassociated with the access point and the key establishment and the key confirmation process are performed prior to completion of an association process to associate the device with the access point.

13. The method of claim 12, wherein the establishing the pre-association security comprises:
receiving, from the device, a first communication frame including first key information for the key establishment process at the access point;
transmitting, to the device, a second communication frame including second key information for the key establishment process at the device and a key confirmation information of the access point for the key confirmation process at the device;
receiving, from the device, a third communication frame including a key information element of the device; and
performing the key confirmation process at the access point based on the key confirmation information of the device without the association process with the device.

14. The method of claim 13, wherein the key establishment process at the access point is performed by:
establishing a shared key of the access point based on the first key information.

15. The method of claim 14, wherein the key confirmation information is a key confirmation element of the device including a device key authorization field that is based on a shared key of the device, the first key information, and the second key information, and
wherein the key confirmation process is performed by:
deriving a confirmation key based on the shared key, the first key information, and the second key information;
generating a key verifier of the access point based on the confirmation key, the first key information, and the second key information or based on an access point public key; and
confirming that the device key authorization field matches the key verifier of the access point.

16. The method of claim 15, wherein the key confirmation is performed further by:
generating a key authorization field of the access point based on the first key information and the second key information and further based on the confirmation key or a private key of the access point; and
generating a key confirmation element of the access point that includes the key authorization field of the access point, wherein the key confirmation information of the access point is the key confirmation element.

17. The method of claim 16, wherein the establishing the pre-association security further comprises:
receiving operating channel information of the device from the device via the third communication frame, the operating channel information of the device indicating a channel utilized by the device; and
confirming that the channel utilized by the device matches a channel utilized by the access point.

18. A non-transitory, processor-readable storage media encoded with instructions that, when executed by processor, cause the processor to perform a method by a device comprising:
establishing a security mechanism with an access point;
performing an association process with the access point to associate with the access point; and
performing an operating channel confirmation process based on operating channel information exchanged during the establishment of the security mechanism, wherein the operating channel confirmation process is performed during or after the association process.

19. The processor-readable storage media of claim 18, wherein the performing the operating channel confirmation process comprises:
confirming that a channel utilized by the access point matches a channel utilized by the device, wherein the channel utilized by the access point is indicated by the operating channel information received from the access point.

20. The processor-readable storage media of claim 18, wherein the security mechanism is established using at least one of a fast initial link setup (FILS), a fast basic service set (BSS) transition, a four way pairwise key handshake process, or a two way group handshake process.
